(19) United States
(12) Patent Application Publication
(10) Pub. No.: US 2025/0369480 A1
(43) Pub. Date: Dec. 4, 2025

(54) COMPOSITE MATERIAL ROLLING BEARING CAGE HAVING IMPROVED BEHAVIOR AND ASSOCIATED ROLLING BEARING UNIT

(71) Applicants: AKTIEBOLAGET SKF, GOTEBORG (SE); SKF Aerospace France S.A.S, Perrigny (FR)

(72) Inventors: Anthony Roger Jeannot JÉRÔME, Valence (FR); Hari Shankar VADIVEL, Nieuwegein (NL); Valentin Roger Claude FLEURY, Romans-sur-Isère (FR); Federico DAL ZILIO, None (IT)

(21) Appl. No.: 19/211,376

(22) Filed: May 19, 2025

(30) Foreign Application Priority Data
May 29, 2024 (IT) 102024000012289
Aug. 1, 2024 (IT) 102024000012277

(51) Int. Cl. F16C 33/44; F16C 33/38

(52) U.S. Cl. CPC F16C 33/44; F16C 33/3856

(57) ABSTRACT

A composite material rolling bearing cage includes an annular body having an axis of symmetry and a plurality of pockets each configured to retain a rolling element. The annular body is formed from a plurality of superimposed layers of reinforcing fibers embedded in a synthetic plastic material, and the fibers of each layer are arranged at an angle to the axis of symmetry. Each pocket has an annular contact zone configured to contact a rolling element, and the annular contact zone has a radial width. The annular contact zone of each pocket is delimited by at least one first layer of the plurality of layers, and the reinforcing fibers of the at least one first layer of the plurality of layers of reinforcing fibers forms an angle of 90°±3° to the axis of symmetry.

### CROSS-REFERENCE

This application claims priority to Italian patent application no. 102024000012277 filed on Aug. 1, 2024, and to Italian patent application no. 102024000012289, filed on May 29, 2024, the contents of which are fully incorporated herein by reference.

### TECHNOLOGICAL FIELD

The present disclosure relates to a rolling bearing cage made from a fiber reinforced composite synthetic plastic material, as well as to an associated rolling bearing unit that includes such a cage.

### BACKGROUND

As it is well known, a rolling bearing unit comprises a rolling bearing having an outer ring, an inner ring and a plurality of rolling bodies (for example balls) interposed between the inner and outer rings to make them relatively rotatable with low friction, and a rolling bearing cage to retain in position the rolling bodies, the cage being arranged in the radial space delimited between the inner ring and the outer ring.

A rolling bearing retaining cage comprises an annular body delimited between radially inner and outer cylindrical surfaces and a plurality of pockets or seats, each configured to house and retain in a freely rotatable manner a respective rolling body of the rolling bearing. The cage body may be made of a fiber reinforced thermoset or thermoplastic material, for example a phenolic resin (or any other suitable synthetic material, e.g., a polyamide) loaded with short or long reinforcing fibers, like: carbon, Kevlar® or glass fibers, natural fibers like: cotton, hemp, flax, and the pockets or seats extend radially through the cage body, e.g. they are radial through-openings.

A bearing cage may be obtained from a preform in the form of a hollow tube that is obtained by molding a synthetic material, then the hollow tube is cut radially in a plurality of slices, each one constituting a cage body. Before or after the cutting operation the pockets or seats are drilled through the axial portions of the preform tube that will form the cage bodies.

The hollow tube constituting the preform may be produced by a process known as “continuous filament winding”, by tightly winding on a metal mandrel tool one or more filaments of composite material comprising continuous fibers impregnated with a synthetic plastic resin.

Here and in the following, for “plastic resin” it is to be understood either a thermoset or thermoplastic synthetic material, e.g., impregnation of fibers can either be made by a liquid thermoset resin or by a solid thermoplastic powder.

After a prefixed number of superimposed radial layers of pre-impregnated fibers are obtained, the preform is cured in a known manner, e.g., in an oven, to cause the consolidation (irreversible consolidation in case of a thermoset resin, reversible consolidation in case of a thermoplastic resin) of the synthetic material impregnating the fibers in a solid matrix, in which the winded fibers remain embedded to constitute a reinforcing material. Curing may occur as disclosed, e.g., in FR 3053624 A1.

### SUMMARY

In a pending patent application of the same Applicant, it is proposed to produce the cage body in a synthetic material having a glass transition temperature equal to or greater than 120° C., e.g., in an epoxy resin, reinforced with high tensile strength fibers like carbon fibers, glass fiber, Kevlar® fibers or other known fibers having equivalent performances, e.g., in place of the traditional cotton fibers.

Though epoxy resin reinforced with long carbon fiber is a composite material already in use for several applications (tooling and aerospace), it may present a number of drawbacks when used, for producing rolling bearing cages, even if it may also bring to considerable advantages.

For examples, in a composite cage body obtained via CFW methods is possible to configurate the preform tube with a sequence of carbon fiber layers oriented with different angles with respect to one another, in order both to prevent the composite preform tube from exhibiting a strong anisotropic behavior and to improve its mechanical properties and, accordingly, the mechanical properties of the final cage body.

However, by adopting such a kind of composite element for realizing a moving component like a retaining cage of a rolling bearing, it has been found that once the composite material is subjected to high centrifugal forces and to the characteristic hitting contact with the rolling bodies present in a bearing cage, it may be subjected to delamination, which causes a high increase of temperature in the application, which may cause as a direct consequence thereof the complete failure of the bearing.

The delamination problem may impair the performances in use of the composite rolling bearing cages and may also cause scraps during the production cycle, thus increasing the production costs. In fact, in the contact zone with the ball, different machining surface conditions between each of the fiber layers may be observed especially in presence of strong difference in the fiber orientations in different layers, which may cause a heterogeneous cutting of the drilling tool and a risk of incipient delamination which can propagate during operation of the cage and lead to the failure of the cage and of the bearing equipped therewith.

An aspect of the present disclosure is to overcome the drawbacks of the prior art by providing a fiber reinforced composite material rolling bearing cage having an improved service life while preserving the mechanical properties of the cage in all use conditions.

It is moreover aspect of the disclosure to provide a fiber reinforced composite material rolling bearing cage having improved interlaminar cohesion, in particular in the most critical portions thereof, e.g. where the hitting contacts with the rolling bodies of the rolling bearing may happen, to avoid delamination, especially in CFW composite material cages, during operation under high rotational speed and high loads.

It is also an aspect of the disclosure to provide a high precision rolling bearing unit equipped with a composite material cage able to be employed in particularly stressful applications, like those requiring high rotation speeds and/or subjected to high loads.

According to the disclosure, there are provided a composite material rolling bearing cage having improved mechanical behavior and an associated rolling bearing unit, as defined in the appended claims.

### BRIEF DESCRIPTION OF THE DRAWINGS

Further characteristics and advantages of the present disclosure will become clear from the following description of non-limiting examples thereof, carried out with reference to the Figures of the attached drawings, in which:

FIG. 1 is a side elevational view, partly in section, of a rolling bearing unit having a bearing cage according to an embodiment of the disclosure.

FIG. 2 is a perspective view of the bearing cage of FIG. 1.

FIG. 3 is a schematic illustration of a possible method of producing the bearing cage of FIG. 2.

FIG. 4 is a detailed perspective view of a portion of preform tube obtained by the method of FIG. 3 where some layers of composite material have been removed for illustration purposes.

FIG. 5 is a radial cross-section of a portion of the bearing cage of FIG. 2.

### DETAILED DESCRIPTION

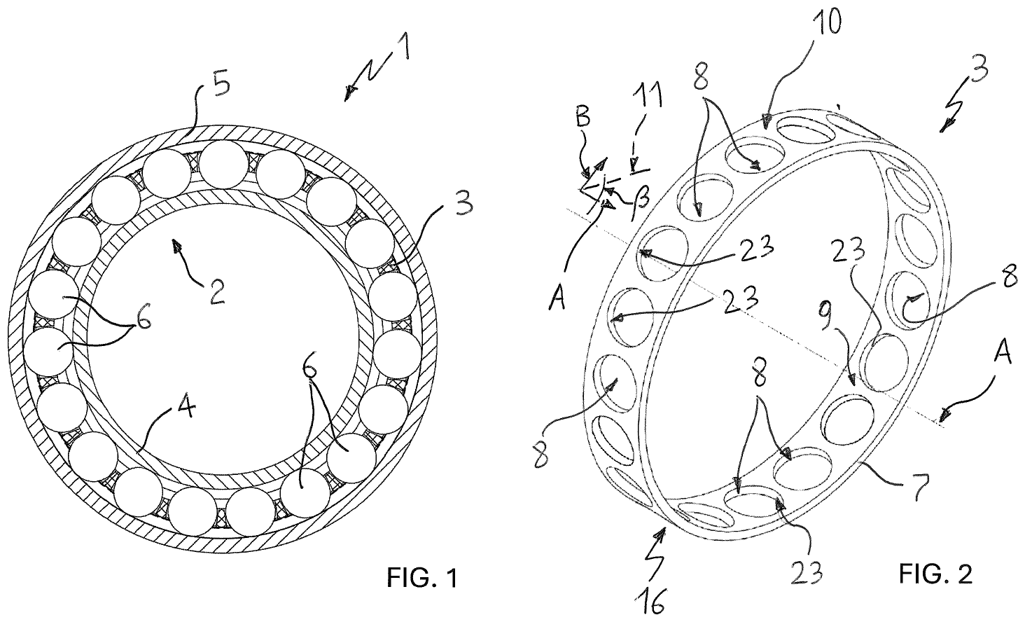

With reference to Figures from 1 to 5, the reference number 1 indicates a rolling bearing unit (FIG. 1) comprising a rolling bearing 2 of any known type and a rolling bearing cage 3, made of a composite material. The rolling bearing comprises an inner ring 4, an outer ring 5 and a plurality of rolling elements or bodies 6, in the non-limiting embodiment shown comprising balls.

The rolling bodies 6 are arranged, in the example shown, in one row of balls around an axis of symmetry A of the rolling bearing, which is also the axis of symmetry of cage 3 (FIG. 2). In different embodiments, not shown for sake of simplicity, the rolling bearing 2 may comprise two rows of rolling bodies arranged side by side and the rolling bodies may be without limitation, balls, cylindrical or conical rolls, small cylinders, according to the operation necessity.

In any case, the rolling bearing cage 3 (FIG. 2) comprises an annular body 7 and a plurality of pockets or seats 8, each of which is configured to freely house in use, in known manner, a respective rolling body 6 of the rolling bearing 2 to correctly keep the rolling bodies 6 spaced apart to each other by a prefixed pitch (circumferential distance).

The annular body 7 has an axis of symmetry A and a predetermined axial width or length. The pockets or seats 8 are provided radially throughout the annular body 7, through respective inner and outer cylindrical radial surfaces 9 and 10 (FIG. 2) of the annular body 7, substantially perpendicularly thereto and, in the example shown, are simple cylindrical radial holes. The cylindrical surfaces 9 and 10 radially delimit the annular body 7 therebetween.

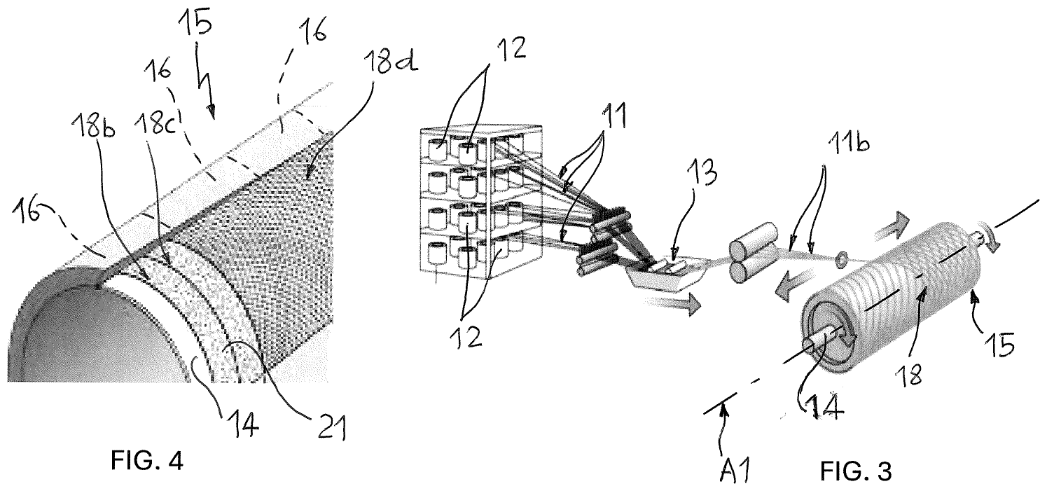

The annular body 7 is made of a fiber-reinforced synthetic plastic material and is preferably obtained by a method known in the art as continuous filament winding, schematically shown in a non-limitative manner in FIG. 3, merely for illustrative purposes and for a better understanding of the disclosure.

With reference to FIG. 3, in a CFW production method a plurality of reinforcing fibers 11 are unwound in known manner from spools 12, are impregnated in known manner with a synthetic plastic resin/material 13, e.g., by making them to pass into the plastic material 13 kept in a fluid state, and then the impregnated reinforcing fibers 11b are wound around a mandrel tool 14 with a prefixed inclination with respect to the axis of symmetry A1 of mandrel tool 14 to obtain a preform tube 15 (FIGS. 3, 4) having different layers 18 of impregnated fibers, e.g., having different orientation, the layers being stacked upon one another. In alternative, pre-peg (pre-impregnated) fibers, or pre-peg sheets or tapes 18 (not shown) of neatly ordered fibers having identical orientation in each sheet or tape may be used, arranging sheets or tapes 18 having fibers with different orientation stacked upon one another to obtain the preform tube 15.

The axis of symmetry A1 of mandrel tool 14 coincides with the axis of symmetry A of the cages 3 to be obtained and to the axis of winding of the fibers 11 around the mandrel tool 14.

To obtain a plurality of annular bodies 7 from a single preform tube 15, the latter is cured in any known and suitable manner (e.g. according to FR 3053624 A1), in order to polymerize the synthetic plastic material or resin 13 to form a solid matrix 21 (FIG. 4), and then is cut radially in slices constituted each by an axial segment 16 (FIG. 4) of the preform tube 15 cut away in a radial direction from the preform tube 15, e.g., along the dotted lines (FIG. 4), such as each axial segment 16 of the preform tube 15 has the same axial width/length of a cage 3 to be obtained.

Before or after the cutting step, but generally after the curing step, a plurality of radial holes configured to constitute the pockets or seats 8 are drilled through each axial segment 16 of the preform tube 15. Accordingly, as shown in FIGS. 4 and 2, each segment 16 comes to constitute, after the cutting step, an annular body 7. Each annular body 7, therefore, comprises a plurality of superimposed layers 18 of reinforcing fibers 11 embedded in a synthetic plastic material 13 and arranged with respect to the axis of symmetry A/A1 according to a prefixed pattern.

In some embodiments, the preform tube 15 may be made from either a polymerized fiber reinforced thermoset rein or in a polymerized thermoplastic resin. In this latter case, the curing step of the preform tube 15 would be no longer necessary, since the thermoplastic powder for impregnating/embedding the fibers needs to be melted (and thus also polymerized) directly on the mandrel 14, e.g., by a laser beam or by a flux of hot air.

According to a feature of the disclosure, the impregnated/embedded fibers 11b of each layer 18 are arranged, e.g., by selecting a proper winding angle, to form, in a plan view, with the axis of symmetry A of the final cage 3 and, with reference to the method of FIG. 3, of the axis of symmetry A1 of the mandrel 14, a preset angle β (FIG. 2), which may differ from the angle β formed in a plan view with the axis of symmetry A/A1 by the fibers 11b of each layer 18 immediately adjacent thereto.

After cutting the preform tube 15 into the axial segments 16, the annular body 7 of each cage 3 that will be obtained by providing further the radial holes constituting the pockets or seats 8, will result in being formed, accordingly, by a plurality of radially superimposed layers 18 of fibers 11b arranged/wound around the axis of symmetry A of the resulting cage 3 with the same pattern and angulation present in the preform tube 15.

It is to be noted that, in each layer 18, the fibers 11b may be wound around, or arranged in a plan view with respect to, axis A of cage 3 according to a parallel or a crisscross pattern, so that angles β of each layer 18 may assume positive and/or negative value. With reference to the schematized reference system sketched in FIG. 2, the angle β may vary from 0° when fibers 11/11b are arranged parallel to axis A and substantially ±90° when the fibers 11/11b are arranged in a plan view, parallel to an axis B perpendicular to axis A, wherein the term “substantially” indicates a working tolerance of +3°.

It is possible, therefore, to obtain a preform tube 15 and, accordingly, cage bodies 7, wherein all the radially superimposed or stacked layers or tapes 18 are arranged to form with the axis of symmetry A of the cage 3, when looking at the cage 3 in a plan view, a prefixed angle β identical or different from one layer or tape and another. For instance, with reference to FIG. 4, a first, radially innermost layer 18b is formed with its impregnated fibers 11b arranged at an angle β of a first value, a second layer 18c, e.g., immediately adjacent thereto, is formed with its impregnated fibers 11b arranged at an angle β of a second value and a third layer 18e immediately adjacent layer 18c, radially on the outside thereof, is formed with its impregnated fibers 11b arranged at an angle β of a third value, and so on.

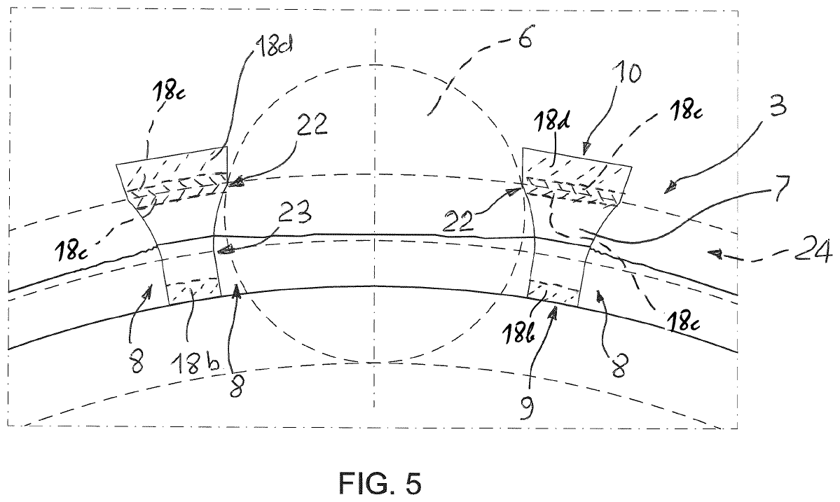

With reference to the schematic sectional view of FIG. 5, each pocket or seat 8 includes an annular contact zone 22 configured in known manner for cooperating in contact, in use, with a rolling body 6 (illustrated in dotted line) of a rolling bearing. The pockets or seats 8, as well as their annular contact zones 22 for cooperation with rolling bodies 6 have a radial width with respect to the axis of symmetry A of the cage 3, namely in the direction of the radial thickness of the cage 3.

The stack of superimposed layers or tapes of reinforcing fibers impregnated with synthetic plastic material delimits, accordingly, a side wall 23 (FIGS. 2 and 5) of each pocket or seat 8 for the whole radial extension thereof, the annular contact zones 22 being constituted by a portion of such side wall 23 of each pocket or seat 8.

According to the main aspect of the disclosure, the annular contact zone 22 of each pocket or seat 8 is delimited by at least one first layer or tape 18, e.g., according to a simplified scheme hereby done for merely better explanation purposes, by the layer or tape 18c, in which the prefixed angle β formed in a plan view by the reinforcing fibers 11 thereof with the axis of symmetry A has to be equal, according to the disclosure, to substantially 90°, wherein the term “substantially” includes a working tolerance of +3°.

Preferably, since the average radial thickness of each layer or tape 18 may be of about 0.15 mm, the annular contact zone 22 of each pocket or seat 8 is delimited by a plurality of first layers or tapes, e.g., 18c, having the reinforcing fibers 11 thereof arranged with respect to the axis of symmetry A of the cage 3, when looking at the cage 3 in a plan view, at a prefixed angle of substantially 90°, considering working tolerances. For non-limiting illustrative purposes only, in FIG. 5 the contact zone 22 is shown as delimited/formed by at least two superimposed layers or tapes 18c, illustrated out of scale for a better comprehension.

According to another aspect of the disclosure, the annular contact zone 22 of each pocket or seat 8 is arranged so as to be delimited by an annular radially middle portion 24 (FIG. 5) of the cage body 3 formed by one or more first layers or tapes 18c arranged in a radial stack also delimiting part of the side wall 23. This middle portion 24 is comprised between the inner and outer cylindrical surfaces 9 and 10 of the cage body 7 and, according to an embodiment of the disclosure, the annular contact zone 22 of the pockets or seats 8 delimited by the annular radially middle portion 24 of the cage body 7 is arranged closer to the outer cylindrical surface 10 of the cage body 7.

In preferred embodiment of the disclosure, radially above and below the annular contact zone 22 of the pockets or seats 8 delimited one or more first layers or tapes 18c, the cage body 7 is formed by a plurality of radially superimposed second layers or tapes, e.g. 18b and 18d, of reinforcing fibers 11 embedded in a synthetic plastic material 13, wherein the prefixed angle of orientation of the reinforcing fibers 11 thereof with respect to the axis of symmetry of the cage 3 viewed in a plan view, progressively decreases in each subsequent layer or tape 18 in steps of finite angular amplitude, e.g., about 15° and preferably no more than 15°, up to reach a minimum angular value in correspondence with the innermost and outermost second layer or tape 18, which define and delimit, respectively, the inner and outer cylindrical surfaces 9, 10 of the cage body 7, i.e., according to the simplified representation made in FIG. 4 for purely illustrative purposes, by layers 18b and 18d, the layer 18d being the outermost one.

The aforementioned minimum value of the angle β that the reinforcing fibers 11 of such second layers or tapes 18 form in a plan view with the symmetry axis A may be close to 15° and in a preferred embodiment is substantially identical in both the innermost and the outermost layers or tapes 18, namely, e.g., layers or tapes 18b and 18d, defining and delimiting the inner and outer cylindrical surfaces 9, 10 of the cage body 7.

According to a further feature of the disclosure, the composite material rolling bearing cage 3 is made using a synthetic plastic material which has a glass transition temperature equal to, or greater than, 90° C., preferably an epoxy resin.

According to a further feature of the disclosure, the reinforcing fibers 11 are chosen from the group consisting of: carbon fibers, glass fibers, Kevlar® fibers, mineral fibers like basalt and quartz fibers, ceramic fibers, e.g., Al2O3 or SiC fibers, metal fibers, e.g., steel or aluminum fibers, organic fibers including cotton, cellulose, flax, jute, hemp and sisal fibers, any synthetic, organic or inorganic fiber similar thereto in tensile strength and stiffness.

According to a preferred embodiment, the reinforcing fibers 11b are continuous fibers 11 embedded in the synthetic plastic material 13 which has been made to impregnate fibers 11.

According to one aspect of the disclosure, the rolling bearing unit 1 in FIG. 1 comprises therefore a rolling bearing, e.g., the rolling bearing 2 or any other model of rolling bearing having a plurality of rolling bodies 6 arranged in a radial space delimited between the inner ring 4 and the outer ring 5 to render them relatively rotatable with low friction, and a rolling bearing cage 3 as described above for retaining the rolling bodies 6 spaced apart. The rolling bearing 2 is preferably of the high precision bearing type, characterized by high speed and/or high load of operation.

Investigations carried out by the engineers of the Applicant showed that 90° fiber inclination plies (namely, e.g., layers or tapes 18) as close as possible to the contact zone 22 of the pocket 8 with the rolling bodies 6 makes it possible to provide maximum stiffness of the cage 3 in most critical zones, so as to have better mechanical performance of the cage 3 at the contact level. In parallel, the poor surface condition problems present in the pocket side walls of the fiber reinforced cages of the prior art due to drilling and delamination are also surprisingly solved by selecting such specific orientation of the fiber plies. The steepest 90° plies are to be located in the middle of the lay-up sequence, then the orientation of the plies is gradually changed going both towards the outer and inner diameters to finish, preferably with 15° fiber orientation plies.

The main advantage of the present disclosure include avoiding risk of cage delamination during machining, having a better surface finishing of the side wall of the cage pockets, which means also less possible friction and better performances at high rotation speed, avoiding or dramatically reducing the risk of cage delamination of the tape layers during operation of the bearings, and achieving high contact loads in the ball pocket area thanks to the 90° plies. All the aims of the disclosure are therefore achieved.

What is claimed is:

1. A composite material rolling bearing cage comprising:
an annular body having a plurality of pockets each configured to retain a rolling element,
wherein the annular body has an axis of symmetry and an axial width,
wherein the pockets are radially disposed around the annular body,
wherein the annular body is formed from a plurality of superimposed layers of reinforcing fibers embedded in a synthetic plastic material,
wherein the fibers of each layer of the plurality of superimposed layers of reinforcing fibers are arranged at an angle to the axis of symmetry,
wherein each pocket comprises an annular contact zone configured to contact the rolling element, the annular contact zone having a radial width, and
wherein the annular contact zone of each pocket is delimited by at least one first layer of the plurality of layers of reinforcing fibers, the reinforcing fibers of the at least one first layer of the plurality of layers of reinforcing fibers forming an angle of 90°=3° to the axis of symmetry.

2. The composite material rolling bearing cage according to claim 1,
wherein said at least one first layer of the plurality of layers of reinforcing fibers comprises a plurality of the first layers of the plurality of layers of the reinforcing fibers.

3. The composite material rolling bearing cage according to claim 1,
wherein each pocket further comprises at least one second layer of the plurality of layers of the reinforcing fibers located radially outward of the at least one first layer of the plurality of layers of reinforcing fibers, the fibers of the at least one second layer of the plurality of layers of reinforcing fibers forming an angle between 15° and 75° to the axis of symmetry.

4. The composite material rolling bearing cage according to claim 3,
wherein each pocket further comprises at least one third layer of the plurality of layers of the reinforcing fibers located radially inward of the at least one first layer of the plurality of layers of reinforcing fibers, the fibers of the at least one third layer of the plurality of layers of reinforcing fibers forming an angle between 15° and 75° to the axis of symmetry.

5. The composite material rolling bearing cage according to claim 3,
wherein a radial thickness of the at least one third layer of the plurality of layers of reinforcing fibers is greater than a radial thickness of the at least one second layer of the plurality of layers of reinforcing fibers.

6. The composite material rolling bearing cage according to claim 5,
wherein the at least one second layer of the plurality of layers of reinforcing fibers comprises a plurality of the second layers of the plurality of layers of reinforcing fibers,
wherein the fibers of each of the second layers of the plurality of layers of reinforcing fibers make an angle to the axis of symmetry less than an angle to the axis of symmetry of a radially inwardly adjacent one of the second layers of the plurality of layers of reinforcing fibers, and
wherein the fibers of each of the third layers of the plurality of layers of reinforcing fibers make an angle to the axis of symmetry less than an angle to the axis of symmetry of a radially outwardly adjacent one of the third layers of the plurality of layers of reinforcing fibers.

7. The composite material rolling bearing cage according to claim 5,
wherein the at least one second layer of the plurality of layers of reinforcing fibers comprises a plurality of the second layers of the plurality of layers of reinforcing fibers,
wherein the fibers of each of the second layers of the plurality of layers of reinforcing fibers make an angle to the axis of symmetry about 15° less than an angle to the axis of symmetry of a radially inwardly adjacent one of the second layers of the plurality of layers of reinforcing fibers, and
wherein the fibers of each of the third layers of the plurality of layers of reinforcing fibers make an angle to the axis of symmetry about 15° less than an angle to the axis of symmetry of a radially outwardly adjacent one of the third layers of the plurality of layers of reinforcing fibers.

8. The composite material rolling bearing cage according to claim 5,
wherein the synthetic plastic material has a glass transition temperature greater than or equal to 90° C.

9. The composite material rolling bearing cage according to claim 8,
wherein the synthetic plastic material comprises an epoxy resin.

10. The composite material rolling bearing cage according to claim 8,
wherein the reinforcing fibers are selected from the group consisting of: carbon fibers, glass fibers, Kevlar® fibers, basalt fibers quartz fibers, Al₂O₃ fibers SiC fibers, steel fibers, aluminum fibers, cotton fibers, cellulose fibers, flax fibers, jute fibers, hemp fibers and sisal fibers.

11. A rolling bearing comprising:
an outer ring,
an inner ring,
a bearing cage according to claim 1 mounted between the inner ring and the outer ring, and
a plurality of the rolling elements mounted in respective ones of the plurality of pockets.

12. A rolling bearing comprising:
an outer ring,
an inner ring,
a bearing cage according to claim 4 mounted between the inner ring and the outer ring, and
a plurality of the rolling elements mounted in respective ones of the plurality of pockets.

13. A rolling bearing comprising:
an outer ring,
an inner ring,
a bearing cage according to claim 6 mounted between the inner ring and the outer ring, and
a plurality of the rolling elements mounted in respective ones of the plurality of pockets.
